(19) United States
(12) Patent Application Publication
(10) Pub. No.: US 2012/0249481 A1
(43) Pub. Date: Oct. 4, 2012

(54) OPTICAL COORDINATE INPUT DEVICE AND COORDINATE CALCULATION METHOD THEREOF

(75) Inventors: Yu-Yen CHEN, Taipei Hsien (TW); RUEY-JIANN LIN, Taipei Hsien (TW)

(73) Assignee: Wistron Corporation, Taipei Hsien (TW)

(21) Appl. No.: 13/435,290

(22) Filed: Mar. 30, 2012

(30) Foreign Application Priority Data
Apr. 1, 2011 (TW) 100111607

(51) Int. Cl. G06F 3/042

(52) U.S. Cl. 345/175

(57) ABSTRACT

An optical coordinate input device and a coordinate calculation method thereof are disclosed. The optical coordinate input device includes a first capture module, a second capture module, and an identification unit. The first capture module and the second capture module are used for generating a first captured image and a second captured image respectively. The identification unit is used for executing a process to transform the first captured image and the second captured image into a first thresholding image and a second thresholding image based on a threshold and calculating a coordinate according to the first thresholding image and the second thresholding image.

### BACKGROUND OF THE INVENTION

1. Field of the Invention

The present invention relates to an optical coordinate input device and a coordinate calculation method thereof, and more particularly, to an optical coordinate input device which can directly capture an object image for processing and a coordinate calculation method thereof.

2. Description of the Related Art

As technology advances, now touch panels have been widely adopted in electronic devices to provide a more intuitive way for users to manipulate their devices. In prior art, touch panels usually use resistive type or capacitive type structure. However, either resistive type or capacitive type touch panels are only suitable for small size panel applications and are not cost effective when used in large size panels.

Therefore, a prior art optical coordinate input device is disclosed to solve the high cost problem of large size resistive or capacitive type touch panels. Please refer to FIG. 1A for a view of a first embodiment of a prior art optical coordinate input device.

In FIG. 1A, the optical coordinate input device 90a comprises a detection area 91, a first capture module 921, a second capture module 922, a first lighting module 931, a second lighting module 932, and a reflector frame 941. The detection area 91 is where an object 96 makes contact with. The first lighting module 931 and the second lighting module 932 can be an infrared type or LED type emitter for emitting invisible light. The first lighting module 931 and the second lighting module 932 emit invisible light to the reflector frame 941; then the first capture module 921 and the second capture module 922 capture images of the reflected light from the reflector frame 941. When the object 96 is in the detection area 91, the object 96 obstructs the light reflected from the reflector frame 941; therefore, the control module 95 can calculate a coordinate of the object 96 according to the captured images from the first capture module 921 and the second capture module 922.

In the prior art, a second embodiment is also disclosed, which is shown in FIG. 1B.

In FIG. 1B, an optical coordinate input device 90b uses a lighting frame 942 instead of the first lighting module 931 and the second lighting module 932 used in the optical coordinate input device 90a. The optical coordinate input device 90b also uses the first capture module 921 and the second capture module 922 to capture images of light emitted from the lighting frame 942; when the object 96 obstructs the light from the lighting frame 942, the control module 95 can immediately calculate a coordinate of the object 96 according to the captured images.

However, since it is necessary for the optical coordinate input device 90a to use the reflector frame 941, and the optical coordinate input device 90b to use the lighting frame 942, problems such as increased manufacturing cost and more design limits could arise.

Therefore, it is necessary to provide a novel optical coordinate input device and a coordinate calculation method thereof to solve the problems encountered in prior art techniques.

### SUMMARY OF THE INVENTION

It is an object of the present invention to provide an optical coordinate input device which can capture an image of an object for processing without using additional auxiliary device or structure.

It is another object of the present invention to provide a coordinate calculation method for the optical coordinate input device of the present invention.

In order to achieve the above object, the optical coordinate input device comprises a first capture module, a second capture module, and an identification module. The first capture module is used for obtaining a first captured image. The second capture module is used for obtaining a second captured image. The identification module is electrically connected with the first capture module and the second capture module and used for executing a process to transform the first captured image and the second captured image into a first thresholding image and a second thresholding image based on a first threshold, and calculating a coordinate according to the first thresholding image and the second thresholding image.

The coordinate calculation method comprises the following steps: capturing a first captured image and a second captured image from a detection area; executing a process to transform the first captured image and the second captured image into a first thresholding image and a second thresholding image respectively based on a first threshold; determining if an object is in both the first thresholding image and the second thresholding image; and if so, then calculating a coordinate.

### BRIEF DESCRIPTION OF THE DRAWINGS

FIG. 1A illustrates a view of a first embodiment of a prior art optical coordinate input device;

FIG. 1B illustrates a view of a second embodiment of the prior art optical coordinate input device;

FIG. 2 illustrates a structural view of an embodiment of an optical coordinate input device of the present invention;

FIG. 2A illustrates an operational view of a first embodiment of the optical coordinate input device of the present invention;

FIG. 2B illustrates an operational view of a second embodiment of the optical coordinate input device of the present invention;

FIG. 3A illustrates a flow diagram of a first embodiment of a coordinate calculation method of the present invention;

FIG. 3B illustrates a view of the optical coordinate input device calculating the position of the object;

FIG. 4A illustrates a flow diagram of a second embodiment of the coordinate calculation method of the present invention;

FIG. 4B illustrates a flow diagram of determining if the object makes contact with the device in the second embodiment of the present invention;

FIG. 5A to FIG. 5D illustrate views of the optical coordinate input device capturing images;

FIG. 6 a structural view of another embodiment of the optical coordinate input device of the present invention;

FIG. 7A illustrates a flow diagram of a third embodiment of the coordinate calculation method of the present invention;

FIG. 7B illustrates a flow diagram of determining if the object makes contact with the device in the third embodiment of the present invention;

FIG. 7C illustrates a view of processing a thresholding image with a connected component labeling approach in the present invention;

FIG. 8 illustrates a flow diagram of a fourth embodiment of the coordinate calculation method of the present invention; and

FIG. 9 illustrates a flow diagram of a fifth embodiment of the coordinate calculation method of the present invention.

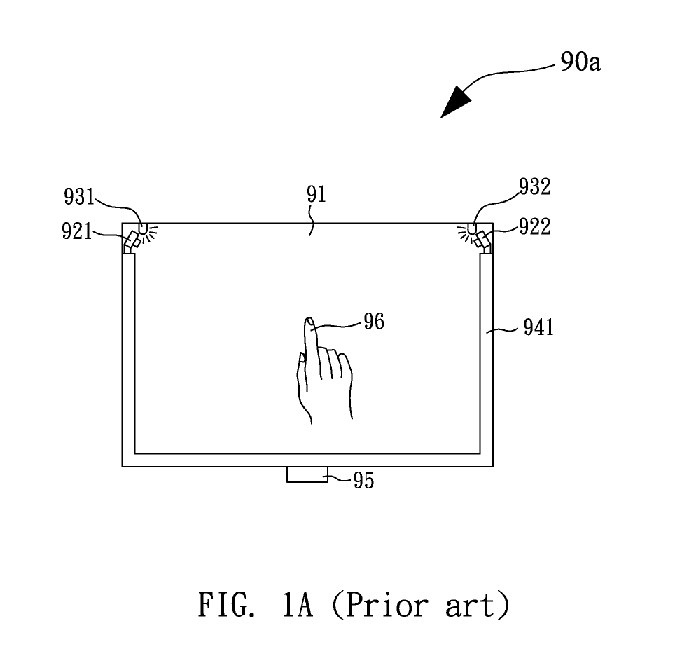

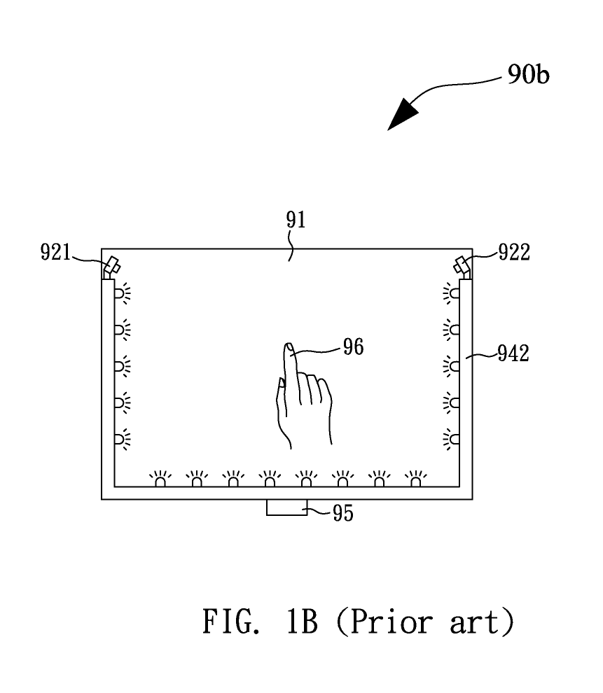

### DETAILED DESCRIPTION OF THE PREFERRED EMBODIMENT

The advantages and innovative features of the invention will become more apparent from the following detailed description when taken in conjunction with the accompanying drawings.

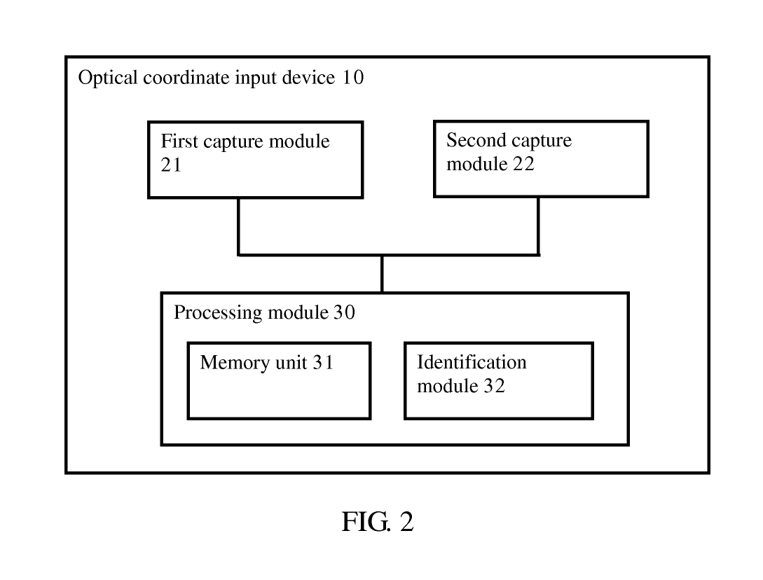

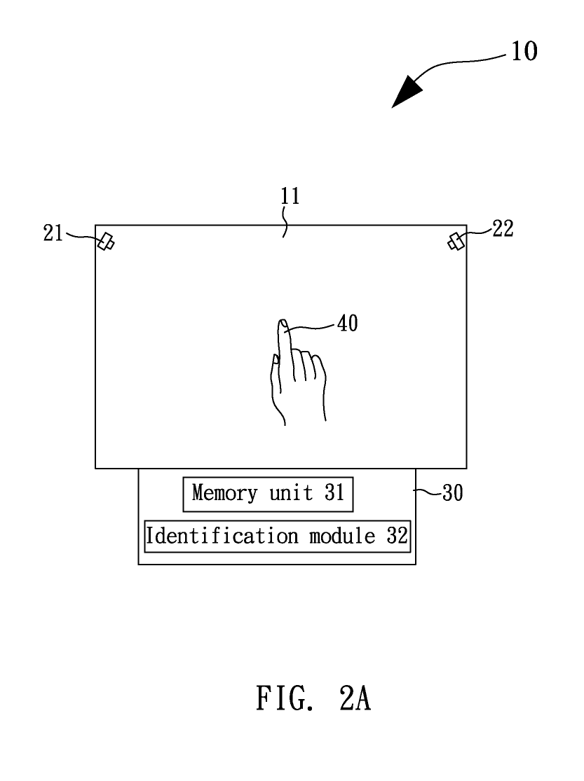

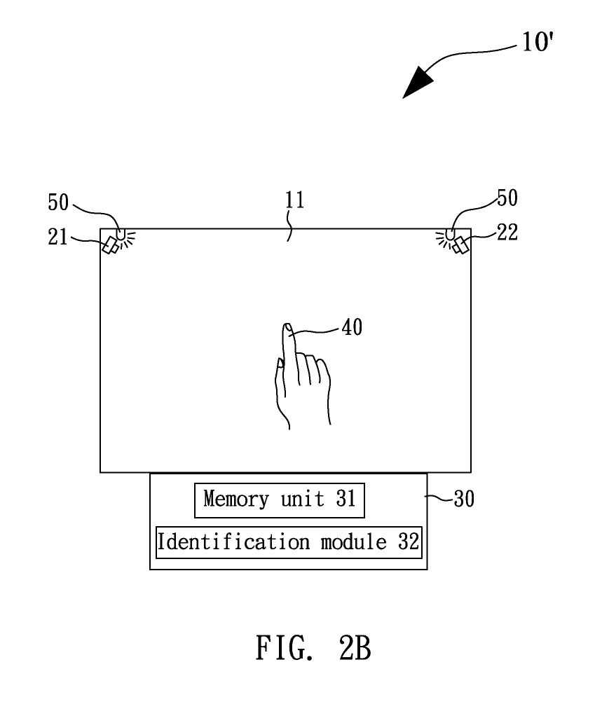

FIG. 2 illustrates a structural view of an embodiment of an optical coordinate input device 10 of the present invention.

The optical coordinate input device 10 can calculate a coordinate of an object 40 (as shown in FIG. 2A) when the object 40 approaches or makes contact with the optical coordinate input device 10. Therefore, the optical coordinate input device 10 can be combined with a display panel to act as a touch panel; but the optical coordinate input device 10 can be adopted in other applications as well. The optical coordinate input device 10 comprises a first capture module 21, a second capture module 22, and a processing module 30.

The first capture module 21 and the second capture module 22 can be CCD type, CMOS type, or any other types of image capturing modules. The first capture module 21 captures a first captured image and establishes a first background image in advance. The second capture module 22 captures a second captured image and establishes a second background image in advance. However, it is not prerequisite to establish background images for following steps.

The processing module 30 is electrically connected with the first capture module 21 and the second capture module 22 to process captured images from the first capture module 21 and the second capture module 22. The processing module 30 comprises a memory unit 31 and an identification module 32. The memory unit 31 is electrically connected with the first capture module 21 and the second capture module 22 to store the first background image and the second background image.

The identification module 32 is electrically connected with the memory unit 31, the first capture module 21, and the second capture module 22; the identification module 32 compares a first captured image and a second captured image to determine if there's an object 40 (as shown in FIG. 2A), and uses a trigonometric function to calculate a coordinate according to the comparison result. The method of calculating a coordinate by the identification module 32 will be described later.

Please refer to FIG. 2A for an operational view of a first embodiment of the optical coordinate input device of the present invention

In the first embodiment, the optical coordinate input device 10 further comprises a detection area 11. The detection area 11 can be a region above a display of the electronic device, but the detection area 11 can be any other regions as well. The detection area 11 is provided for the object 40 to approach or to make contact with. The object 40 can be a user's finger, touch pen, or any other contact means; in the embodiments of the present invention, the object 40 uses the user's finger as an example.

In the first embodiment of the present invention, the first capture module 21 and the second capture module 22 are disposed at adjacent corners of the detection area 11 respectively, for example, the upper right and upper left corners, the upper right and lower right corners, the upper left and lower left corners, or the lower right and lower left corners of the detection area 11 for capturing the image of the detection area 11. Please notice that the optical coordinate input device 10 can have more than two capture modules and the capture modules can be disposed at different corners of the detection area 11 respectively.

The first capture module 21 and the second capture module 22 can capture a first captured image and a second captured image from the detection area 11 at any time, and can capture a first background image and a second background image from the detection area 11 in advance when the object 40 hasn't approach the detection area 11 yet. The first background image and the second background image can be images captured by the first capture module 21 and the second capture module 22 with respect to the frame of the detection area 11 respectively, but the first background image and the second background image can be any other images captured by the first capture module 21 and the second capture module 22.

Please notice that the frame of the detection area 11 is not necessarily reflective or luminous; and the frame can be any type of frame as long as it can be distinguished from the object 40.

After the first capture module 21 captures the first captured image and the first background image and the second capture module 22 captures the second captured image and the second background image, the identification module 32 can first clip the first captured image and the second captured image, and then uses a first threshold and a second threshold to filter the clipped images to reduce image noises, thereby determining if an object 40 approaches or makes contact with the detection area 11. Finally the identification module 32 uses a trigonometric function to calculate a coordinate of the object 40, but the identification module 32 can use other functions to calculate the coordinate. The method of calculating the coordinate of the object 40 by the identification module 32 will be described in details later.

FIG. 2B illustrates an operational view of a second embodiment of the optical coordinate input device of the present invention.

In the second embodiment of the present invention, the optical coordinate input device 10′ additionally comprises a lighting module 50 for emitting light. The first capture module 21 and the second capture module 22 can use the light emitted by the lighting module 50 to more precisely capture images and to help the identification module 32 more accurately identify the coordinate of the object 40. Please notice that the present invention is not limited to the aspect of the second embodiment.

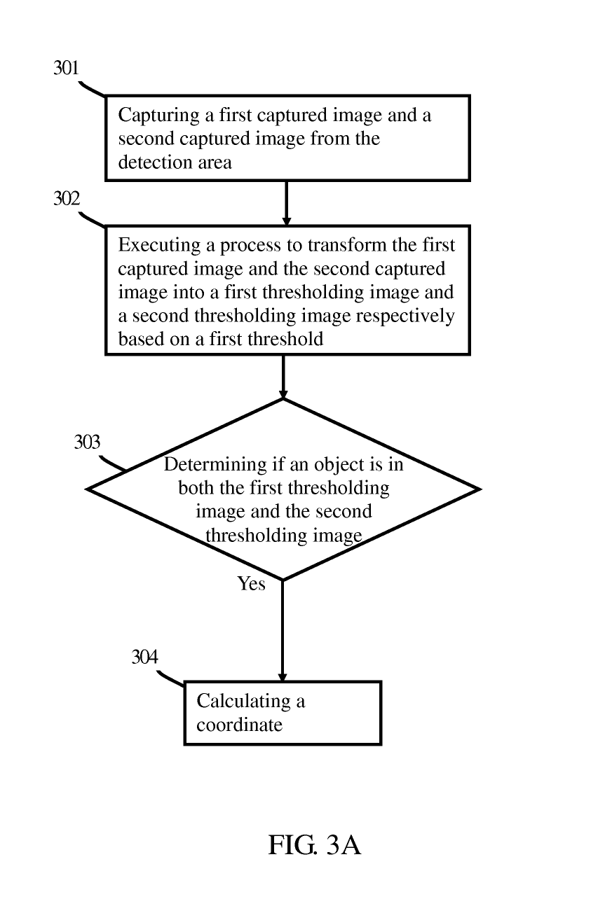

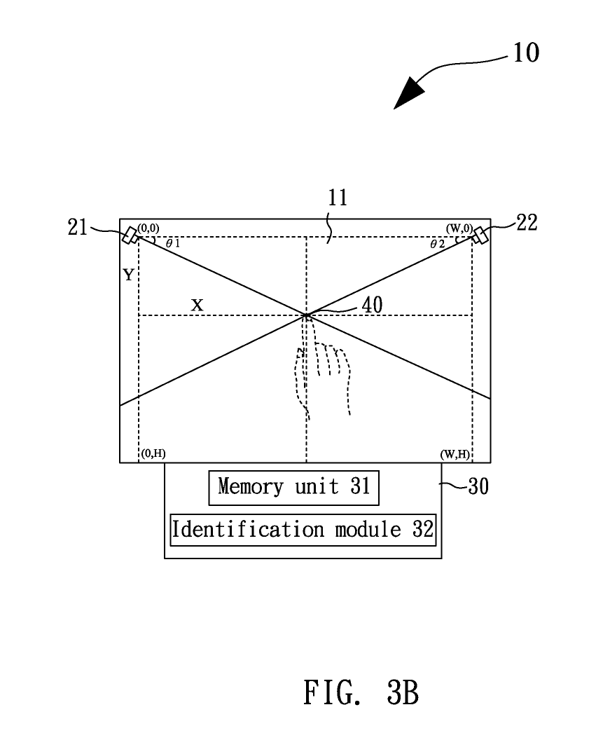

FIG. 3A illustrates a flow diagram of a first embodiment of a coordinate calculation method of the present invention. Please notice that although the coordinate calculation method is used here for the optical coordinate input device 10 in this embodiment, the coordinate calculation method can be applied in other devices other than the optical coordinate input device 10.

First the method starts at step 301, the first capture module 21 and the second capture module 22 capture a first captured image and a second captured image from the detection area 11.

Then the method proceeds to step 302, the identification module 32 executes a process to transform the first captured image and the second captured image into a first thresholding image and a second thresholding image respectively based on a first threshold. This process will be described in details later.

The method proceeds to step 303, the identification module 32 uses the first thresholding image and the second thresholding image to determine if the object 40 approaches or makes contact with the detection area 11 in the both first thresholding image and the second thresholding image. The determining step will be further described later.

If the identification module 32 determines that the object 40 makes contact with the detection area 11, the method goes to step 304. Please also refer to FIG. 3B for a view of the optical coordinate input device 10 calculating the position of the object.

In an embodiment of the present invention, the identification module 32 uses a trigonometric function to calculate the coordinate of the object 40, but the identification module can use other functions to calculate the coordinate. In detail, assume that the detection area 11 has a width of W and a height of H, a first angle θ1 obtained with respect to an image of the object 40 captured by the first capture module 21, and a second angle θ2 obtained with respect to an image of the object 40 captured by the second capture module 22. Then a coordinate X of the object 40 on the horizontal axis (or X-axis) can be obtained by the following trigonometric function:

$$X = \frac{W * tan θ 2}{tan θ 1 + tan θ 2}$$

And a coordinate Y of the object 40 on the vertical axis (or Y-axis) can be obtained by the following equation:

Y=X*tan θ1

Please notice that the present invention can use mathematical functions other than the equations described above or a trigonometric function to calculate the coordinate of the object 40.

When the coordinate of the object 40 is obtained, the identification module 32 outputs the coordinate to other electronic device for processing touch control functions, which are known in the prior art and will not be further described.

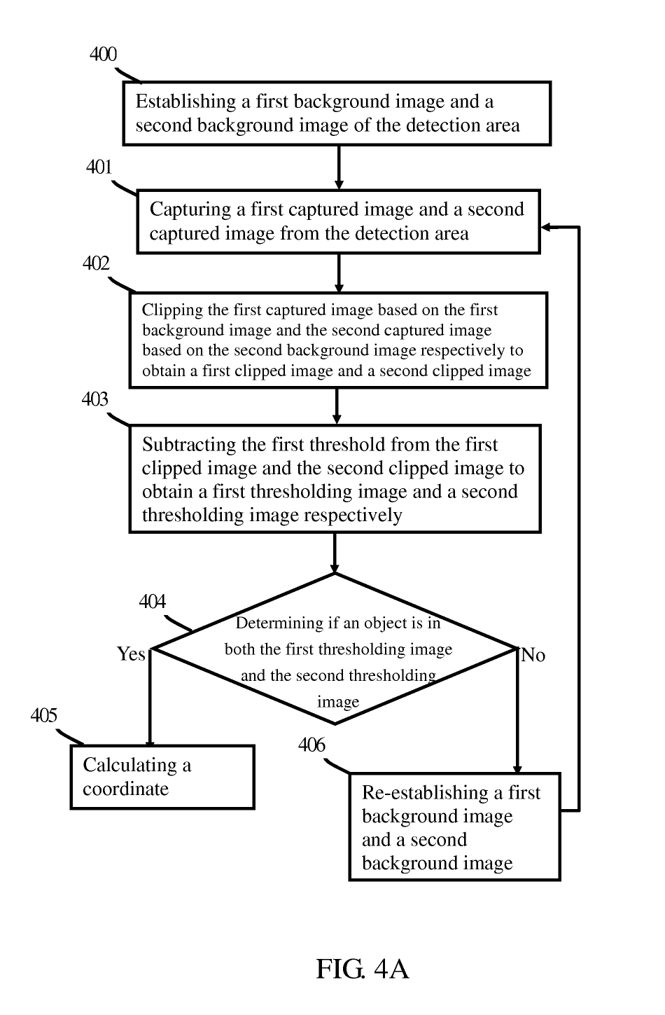

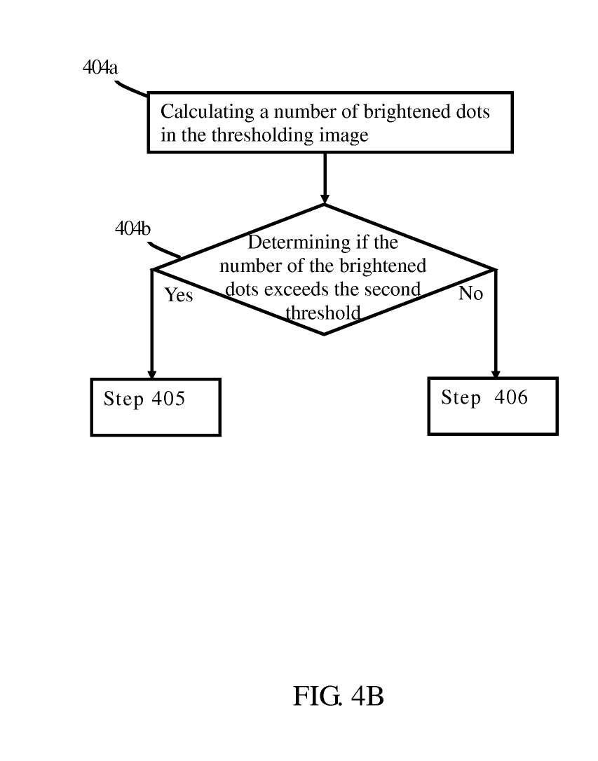

FIG. 4A illustrates a flow diagram of a second embodiment of the coordinate calculation method of the present invention.

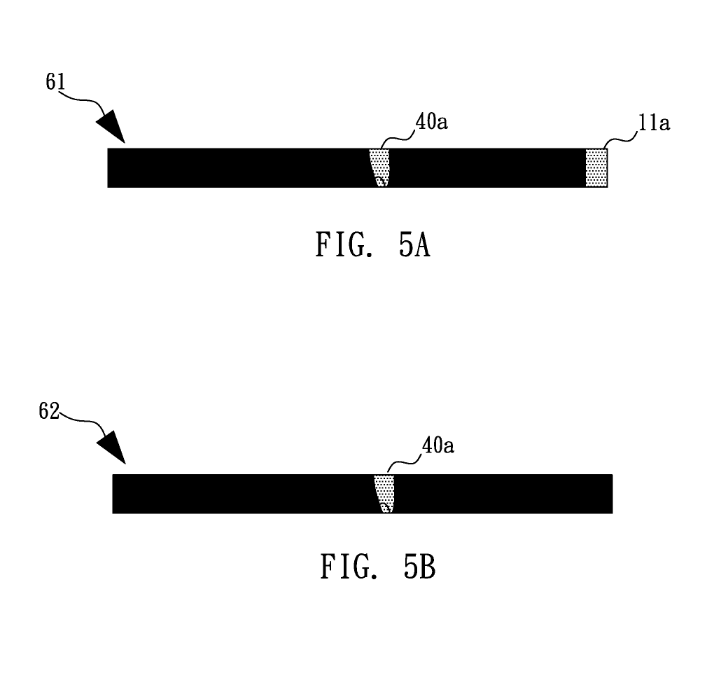

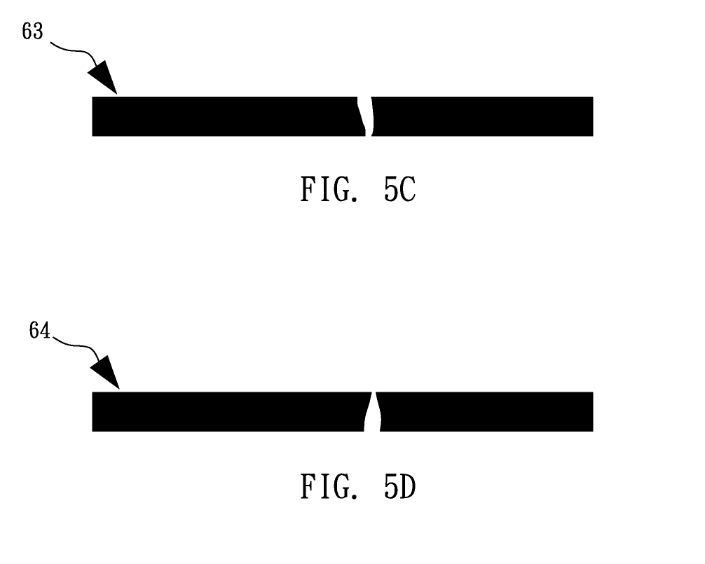

In the following steps, please also refer to FIG. 5A to FIG. 5D for views of the optical coordinate input device capturing images.

First the method starts at step 400, when the system initiates, the optical coordinate input device 10 uses the first capture module 21 and the second capture module 22 to capture images of the detection area 11 as a first background image and a second background image respectively, and stores the first background image and the second background image in the memory unit 31.

Then the method proceeds to step 401, the first capture module 21 and the second capture module 22 continue to capture images from the detection area 11 to obtain a first captured image and a second captured image. As shown in FIG. 5A, a captured image 61 captured by either the first capture module 21 or the second capture module 22 is illustrated. From FIG. 5A, it is known that the captured image 61 can comprise both an image 40a of the object 40 and a background image. This background image could comprise a frame image 11a or other images in the detection area 11.

Then the method proceeds to step 402, the identification module 32 uses the first background image and the second background image stored in the memory unit 31 to compares the first background image with the first captured image, and to compare the second background image with the second captured image respectively, in order to determine if the first background image is different from the first captured image, and if the second background image is different from the second captured image.

In the second embodiment of the present invention, the identification module 32 clips the first captured image based on the first background image and clips the second captured image based on the second background image respectively to obtain a first clipped image and a second clipped image. Therefore, the image 40a of the object 40 can be identified more clearly. However, there are other ways to highlight the image 40a. As shown in FIG. 5B, the identification module 32 clips the captured image 61 to obtain a clipped image 62. In the clipped image 62, the frame image 11a is removed, and only the image 40a of the object 40 is shown. Since the image clipping techniques are known in the art, they will not be further described.

Then the method proceeds to step 403: using the first threshold to transform the first clipped image and the second clipped image to obtain a first thresholding image and a second thresholding image respectively.

The identification module 32 uses the first threshold to filter the first clipped image and the second clipped image obtained in step 402 to obtain the first thresholding image and the second thresholding image respectively. Please also refer to FIG. 5C. First the identification module 32 subtracts the first threshold from the gray scale value of each pixel of the clipped image 62 in FIG. 5B. Then the identification module 32 sets the pixels having remainder gray scale values greater than zero to have the maximum gray scale value, and the pixels having remainder gray scale values lower than zero to have the minimum gray scale value so as to obtain a thresholding image 63, wherein the process is called a Bilevel thresholding process and will not be further described since it is known in the art.

Then the method proceeds to step 404, the identification module 32 determines if the object 40 approaches or makes contact with the detection area 11 in both the first thresholding image and the second thresholding image.

FIG. 4B illustrates a flow diagram of determining if the object makes contact with the device.

First the identification module 32 proceeds to step 404a, the identification module 32 accumulates the number of bright dots on each column along the X coordinate to obtain a horizontal histogram 64 shown in FIG. 5D.

Then the process goes to step 404b, the identification module 32 calculates the number of the bright dots in the horizontal histogram 64 to determine if the number of the bright dots for one column exceeds the second threshold.

The identification module 32 uses the second threshold to determine that when a number of bright dots of a column in the horizontal histogram 64 exceeds the second threshold, the identification module 32 proceeds to step 405.

For example, on the horizontal histogram 64 obtained by the first capture module 21, the position having the maximum number of bright dots in the horizontal histogram 64 corresponds to the exact position of the first captured image of the object 40. The exact position of the second captured image of the object 40 can be obtained similarly. Then the identification module 32 uses the trigonometric function or other mathematical functions to calculate the coordinate of the object 40.

If the identification module 32 determines that the object 40 does not make contact with the detection area 11, then the method proceeds to step 406: re-establishing the first background image and the second background image.

If the number of bright dots does not exceed the second threshold, then no object approaches or makes contact with the detection area 11. When the identification module 32 determines that the object 40 does not make contact with the detection area 11, the processing module 30 can control the first capture module 21 and the second capture module 22 to re-establish the first background image and the second background image according to the brightness of the environment or other environment changes, and to more accurately determine the coordinate of the object 40. Then the method goes back to step 401 to capture a new first captured image and a new second captured image again. On the other hand, if one of the first captured image and the second captured image does not show the object 40, then an error could happen to the first capture module 21 or the second capture module 22; therefore, the method has to go back to step 401 to capture the first captured image and the second captured image again.

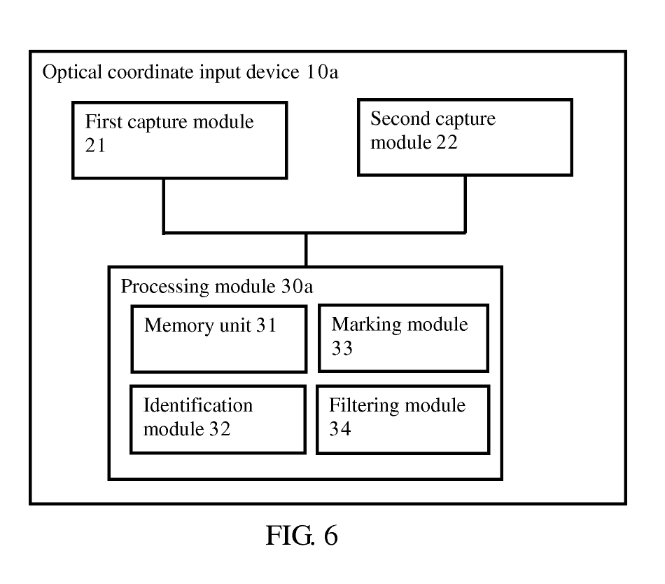

Please notice that the present invention is not limited to the structure of the optical coordinate input device 10 shown in FIG. 2. Please refer to FIG. 6 for a structural view of another embodiment of the optical coordinate input device of the present invention.

In another embodiment of the present invention, the processing module 30a of the optical coordinate input device 10a also comprises a marking module 33 and a filtering module 34. The marking module 33 is electrically connected with the identification module 32 to execute a connected component labeling approach to the thresholding images to obtain at least one object image. Then the identification module 32 compares the largest object image with a pre-defined object image template. In this embodiment, the object image template could be a finger image template. When the object image corresponds to the finger image template, it is assumed that the finger makes contact with the detection area 11. The pre-defined object image template could be stored in the memory unit 31 in advance, and the object image template could be a finger image template or a touch pen image template, or any other suitable image templates.

The filtering module 34 of the optical coordinate input device 10a is electrically connected with the first capture module 21, the second capture module 22, and the identification module 32; the filtering module 34 filters the first captured image from the first capture module 21 and the second captured image from the second capture module 22 based on a color to obtain filtered images corresponding to skin color. However, the filtered color is not limited to skin color.

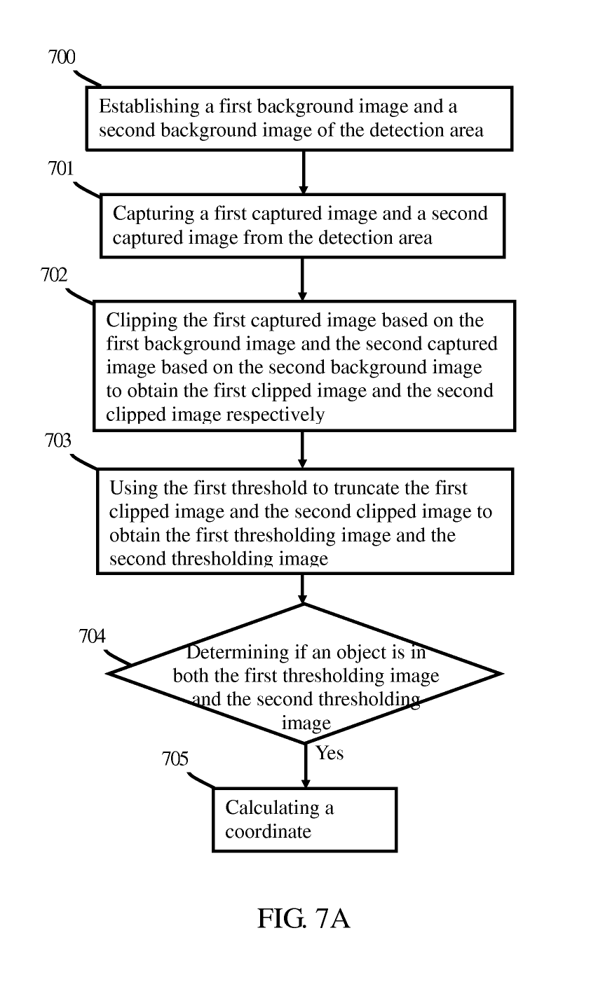

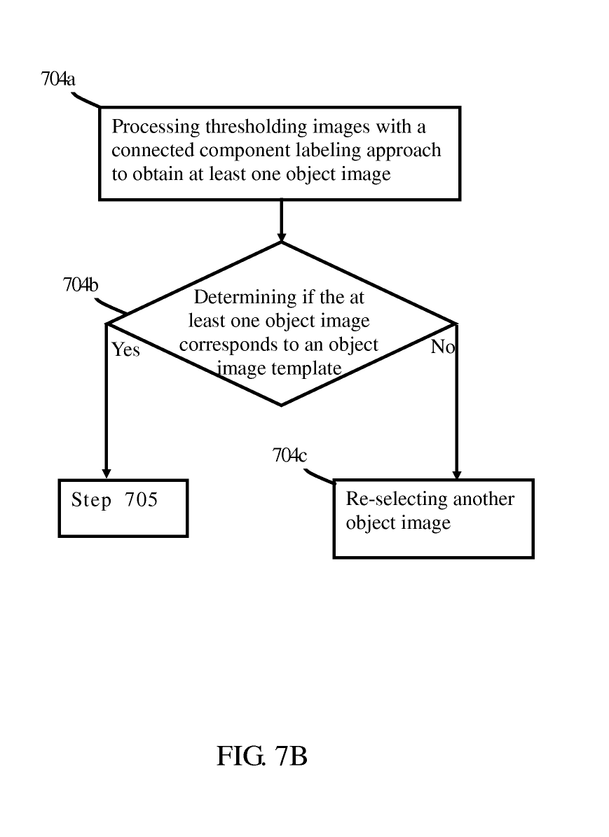

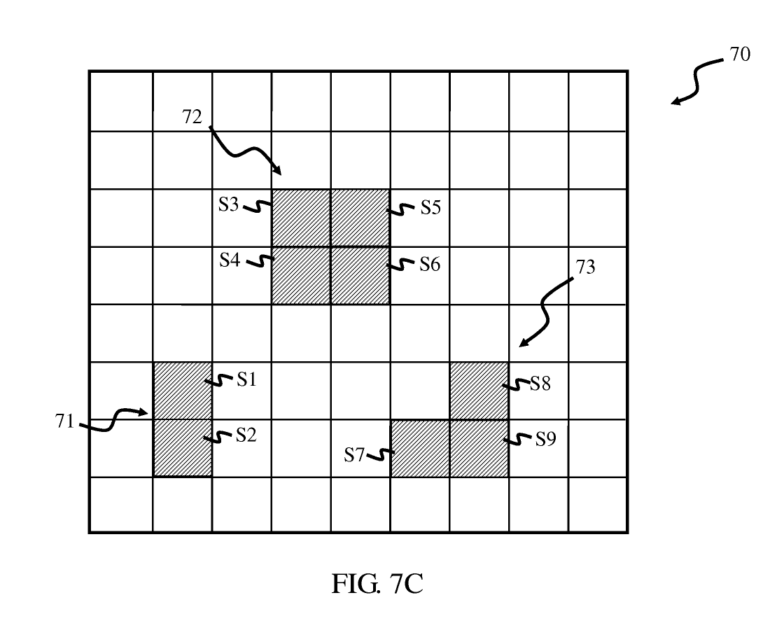

As to detailed steps of finding a finger image, please refer to FIG. 7A to FIG. 7B for a flow diagram of a third embodiment of the coordinate calculation method of the present invention.

First the method starts at step 700: establishing a first background image and a second background image of the detection area 11 in advance.

The optical coordinate input device 10a uses the first capture module 21 to capture the first background image and the second capture module 22 to capture the second background image and stores the images in the memory unit 31.

Then the method proceeds to step 701: capturing a first captured image and a second captured image from the detection area.

The first capture module 21 and the second capture module 22 continue to capture images from the detection area 11 to obtain the first captured image and the second captured image, such as the captured image 61 shown in FIG. 5A.

Then the method proceeds to step 702: clipping the first captured image based on the first background image and clipping the second captured image based on the second background image to obtain the first clipped image and the second clipped image respectively.

The identification module 32 clips the first captured image based on the first background image stored in the memory unit 31 and clipping the second captured image based on the second background image stored in the memory unit 31 to obtain the first clipped image and the second clipped image respectively, such as the clipped image 62 shown in FIG. 5B.

Then the method proceeds to step 703: using the first threshold to truncate the first clipped image and the second clipped image to obtain the first thresholding image and the second thresholding image respectively.

The identification module 32 subtracts the first threshold from the first clipped image and the second clipped image obtain in step 702 to obtain the first thresholding image and the second thresholding image respectively, such as the thresholding image 63 shown in FIG. 5C.

Step 700 to step 703 are basically the same as step 400 to step 403 respectively and will not be further described.

Then the method proceeds to step 704: determining if an object is both in the first thresholding image and the second thresholding image.

The identification module 32 uses the first thresholding image and the second thresholding image to determine if the object 40 approaches or makes contact with the detection area 11 in both images.

Please refer to FIG. 7B for a flow diagram of determining if the object makes contact with the device in the third embodiment of the present invention.

First the marking module 33 starts at step 704a: processing thresholding images with a connected component labeling approach to obtain at least one object image.

The marking module 33 processes thresholding images with the connected component labeling approach. The connected component labeling approach uses the first thresholding image and the second thresholding image obtained in step 703 to connect the image block having the same gray scale value in both thresholding images to find at least one object image. Please refer to FIG. 7C for a view of processing a thresholding image with a connected component labeling approach in the present invention.

In FIG. 7C, the marking module 33 sequentially scans a plurality of blocks of the thresholding image 70 to find the image blocks S1˜S9, then the marking module 33 determines if an image block has image blocks adjacent to its left or upper side and marks the adjacent image blocks. Please notice that only adjacent blocks in the horizontal and vertical directions are taken into account in FIG. 7C, however, images blocks in the diagonal directions can be taken into account as well.

For example, when the marking module 33 scans the image block S1 and finds that there's no image block on its left or upper side, the marking module 33 gives a new mark to the image block S1. When the marking module 33 scans the image block S2 and finds the image block S1 on the upper side of the image block S2, the marking module 33 gives the same mark as the image block S1 to the image block S2. Therefore, the first object image 71 is thus obtained. As to image block S6, since the image block S4 and the image block S5 have the same mark, the marking module 33 gives the same mark to the image block S6. Therefore the second object image 72 is thus obtained.

As to the image block S9, since the image block S7 and the image block S8 have different marks, the marking module 33 gives one of the marks of S7 and S8 to the image block S9 and at the same time marks the different marks as equivalent marks. After the marking module 33 scans the thresholding image 70, the marking module 33 changes all equivalent marks to the same mark and obtain the third object image 73. By executing the above steps, the marking module 33 can find all the object images in the thresholding image 70. The connected component labeling approach will not be further described since it is well known in the art.

Then the method proceeds to step 704b, the identification module 32 determines if the object image obtained in step 704a corresponds to an object image template stored in the memory unit 31 in shape. And the identification module 32 can normalize the size of the object image in advance, to let the size of the object image the same as the size of the object image template for comparison. The object image template can be a finger image template, a touch pen image template, or any other image templates. In FIG. 7C, since the thresholding image 70 comprises a plurality of object images, the identification module 32 starts from the second object image 72 having the largest area to compare it with the object image template.

When the second object image 72 does not match the object image template, the identification module 32 goes back to step 704c to re-select another object image.

According to the order of the area size, the identification module 32 selects the third object image 73 and compares it with the object image template, then the identification module 32 repeats the steps until all the object images are compared.

When the identification module 32 compares the object image with the object image template to find a match in the shape of both images, the identification module 32 goes to step 705.

When the identification module 32 determines that the first object image 71 and the object image template have the same shape, then a central point of the first object image 71 is regarded as the exact position of the object 40 in the captured image. Thus the optical coordinate input device 10a can locate exact positions of the object 40 in the first and the second captured image with the same method. Then the identification module 32 uses the trigonometric function or other mathematical functions to calculate the coordinate of object 40.

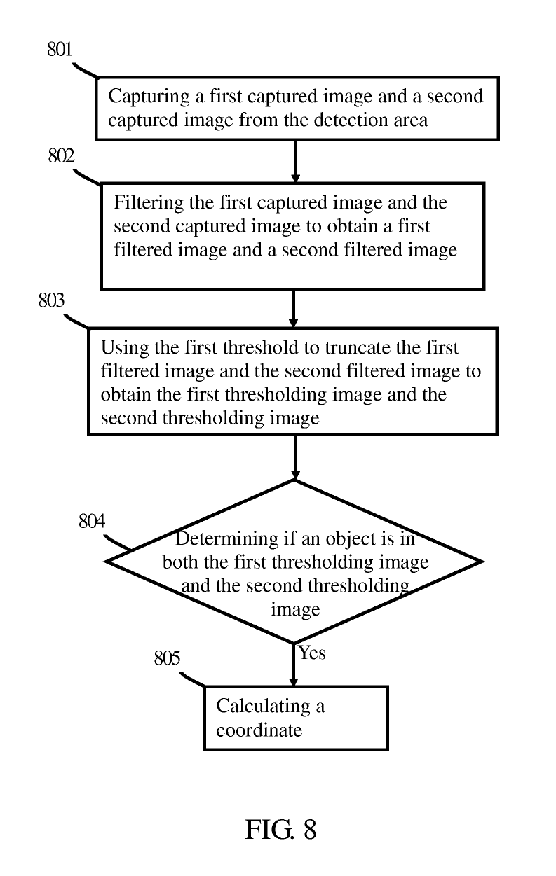

FIG. 8 illustrates a flow diagram of a fourth embodiment of the coordinate calculation method of the present invention.

The method starts at step 801, the first capture module 21 and the second capture module 22 continue to capture images from the detection area 11 to obtain the first captured image and the second captured image. The step 801 is basically the same as the step 401 and will not be further described.

Then the method proceeds to step 802: filtering the first captured image and the second captured image to obtain a first filtered image and a second filtered image.

The filtering module 34 filters the first captured image and the second captured image based on a color to obtain the first filtered image and the second filtered image. In the present invention, the filtering module 34 uses the skin color for filtering; however, the filtered color is not limited to skin color.

The method proceeds to step 803: using the first threshold to truncate the first filtered image and the second filtered image to obtain the first thresholding image and the second thresholding image respectively.

The identification module 32 subtracts the first threshold from the first filtered image and the second filtered image to obtain the first thresholding image and the second thresholding image respectively. Since step 803 is basically the same as step 403 except that clipped images in step 403 are replaced by filtered images, it will not be further described.

Then the method proceeds to step 804: determining if an object is in both the first thresholding image and the second thresholding image.

The identification module 32 uses the first thresholding image and the second thresholding image to determine if the object approaches or makes contact with the detection area 11 in both images. Step 804 uses the same steps as described in step 704a to step 704c to determine if the object approaches or makes contact with the detection area 11 and thus will not be further explained.

Finally, if the identification module 32 determines the object 40 makes contact with the detection area 11, then the method proceeds to step 805 to calculate exact positions of the object 40 in the first and second captured images. Then the identification module 32 uses the trigonometric function or other mathematical functions to calculate a coordinate of the object 40.

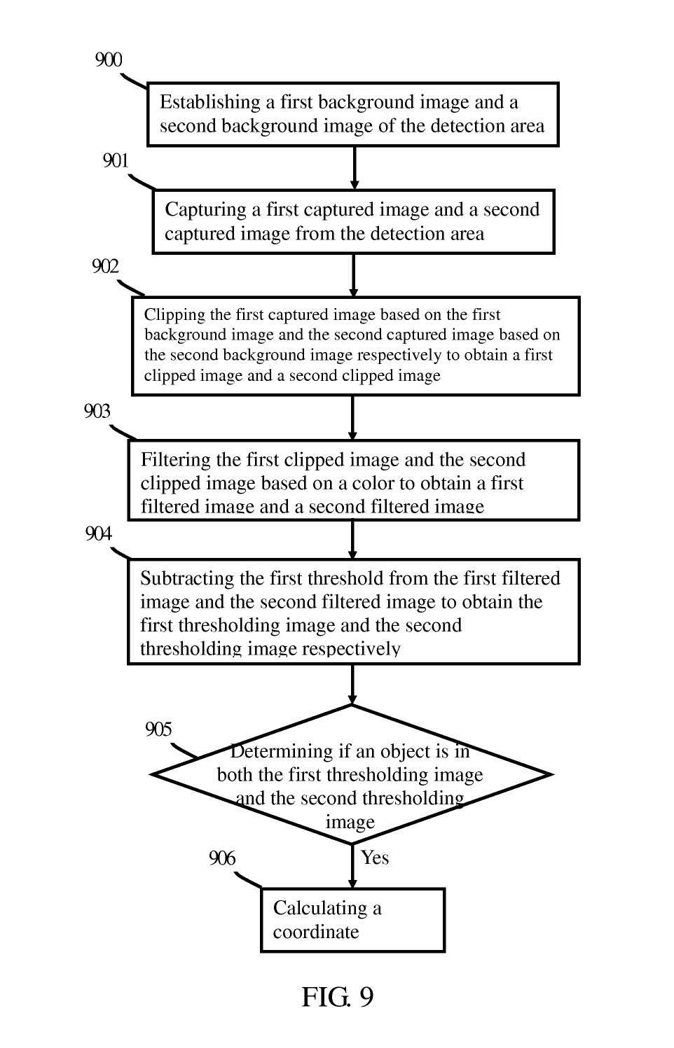

Finally, please refer to FIG. 9 for a flow diagram of a fifth embodiment of the coordinate calculation method of the present invention.

First the method proceeds to step 900, the optical coordinate input device 10a uses the first capture module 21 to capture a first background image and the second capture module 22 to capture a second background image and stores the background images in the memory unit 31.

Then the method proceeds to step 901, the first capture module 21 and the second capture module 22 continue to capture images from the detection area 11 to obtain a first captured image and a second captured image.

Then the method proceeds to step 902, the identification module 32 clips the first captured image based on the first background image and clips the second captured image based on the second background image respectively to obtain a first clipped image and a second clipped image.

Step 900 to step 902 are basically the same as step 400 to step 402 respectively and will not be further described.

Then the method proceeds to step 903: filtering the first clipped image and the second clipped image based on a color to obtain a first filtered image and a second filtered image.

The filtering module 34 filters the first captured image and the second captured image based on a color to obtain the first filtered image and the second filtered image. In the present invention, the filtering module 34 uses the skin color for filtering; however, the filtered color is not limited to skin color.

Then the method proceeds to step 904, the identification module 32 subtracts the first threshold from the first filtered image and the second filtered image obtained in step 903 to obtain the first thresholding image and the second thresholding image respectively. Since step 903 and step 904 are similar to step 403 or step 803 except that clipped images are replaced by captured images, it will not be further described.

Then the method proceeds to step 905, the identification module 32 uses the first thresholding image and the second thresholding image to determine if the object 40 approaches or makes contact with the detection area 11 in both images. Step 905 uses the same steps as described in step 704a to step 704c to determine if the object approaches or makes contact with the detection area 11 and thus will not be further explained.

Finally, when the identification module 32 determines that the object 40 makes contact with the detection area 11, the method proceeds to step 906 to calculate an exact position of the object 40 in the first and second captured images. Then the identification module 32 uses the trigonometric function or other mathematical functions to calculate a coordinate of the object 40.

Please notice that the present invention is not limited to the order of the steps of the coordinate calculation method; the present invention can have other orders as long as the object is achieved.

Please notice that the above-mentioned embodiments are only for illustration. It is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. An optical coordinate input device comprising:
a first capture module for obtaining a first captured image;
a second capture module for obtaining a second captured image; and
an identification module electrically connected with the first capture module and the second capture module and used for executing a process to transform the first captured image and the second captured image into a first thresholding image and a second thresholding image based on a first threshold, and calculating a coordinate according to the first thresholding image and the second thresholding image.

2. The optical coordinate input device as claimed in claim 1 further comprising a detection area, wherein
the first captured image is captured by the first capture module from an image in the detection area; and
the second captured image is captured by the second capture module from the image in the detection area.

3. The optical coordinate input device as claimed in claim 2, wherein the first capture module and the second captured image are disposed at adjacent corners of the detection area respectively.

4. The optical coordinate input device as claimed in claim 3 further comprising a memory unit electrically connected with the first capture module and the second capture module, wherein:
the first capture module establishes a first background image in advance;
the second capture module establishes a second background image in advance;
the memory unit stores the first background image and the second background image; and
the identification module clips the first captured image based on the first background image and clips the second captured image based on the second background image to obtain a first clipped image and a second clipped image respectively; wherein the first thresholding image and the second thresholding image are obtained by using the first threshold to truncate the first clipped image and the second clipped image.

5. The optical coordinate input device as claimed in claim 4, wherein the identification module further determines if a first number of brightened dots of the first thresholding image and a second number of the brightened dots of the second thresholding image exceed a second threshold respectively.

6. The optical coordinate input device as claimed in claim 5 further comprising at least one lighting module to provide a light source for the first capture module and the second capture module.

7. The optical coordinate input device as claimed in claim 3, further comprising:
a memory unit for storing an object image template;
a marking module electrically connected with the identification module to execute a connected component labeling approach based on the first thresholding image and the second thresholding image respectively to obtain at least one object image, and to determine if the at least one object image corresponds with the object image template, if so, then the identification module calculates the coordinate.

8. The optical coordinate input device as claimed in claim 7, wherein:
the first capture module captures a first background image in advance;
the second capture module captures a second background image in advance;
the memory unit stores the first background image and the second background image; and
the identification module clips the first captured image based on the first background image and clips the second captured image based on the second background image respectively to obtain a first clipped image and a second clipped image.

9. The optical coordinate input device as claimed in claim 8, wherein the first thresholding image and the second thresholding image are obtained by using the first threshold to truncate the first clipped image and the second clipped image.

10. The optical coordinate input device as claimed in claim 8, wherein the optical coordinate input device further comprises a filtering module for filtering the clipped image and the second clipped image to obtain a first filtered image and a second filtered image; and wherein the first thresholding image and the second thresholding image are obtained by using the first threshold to filter the first filtered image and the second filtered image.

11. The optical coordinate input device as claimed in claim 7, wherein the optical coordinate input device further comprises a filtering module for filtering the first captured image and the second captured image to obtain a first filtered image and a second filtered image; and wherein the first thresholding image and the second thresholding image are obtained by using the first threshold to filter the first filtered image and the second filtered image.

12. The optical coordinate input device as claimed in claim 7, wherein the identification module further normalizes the object image.

13. The optical coordinate input device as claimed in claim 7, wherein the object image template is a finger image template or a touch pen image template.

14. The optical coordinate input device as claimed in claim 1 further comprising a memory unit electrically connected with the first capture module and the second capture module, wherein:
the first capture module establishes a first background image in advance;
the second capture module establishes a second background image in advance;
the memory unit stores the first background image and the second background image; and
the identification module clips the first captured image based on the first background image and the second captured image based on the second background image to obtain a first clipped image and a second clipped image respectively; wherein the first thresholding image and the second thresholding image are obtained by using the first threshold to truncate the first clipped image and the second clipped image.

15. The optical coordinate input device as claimed in claim 14, wherein the identification module further determines if a first number of bright dots of the first thresholding image and a second number of the bright dots of the second thresholding image exceed a second threshold respectively.

16. The optical coordinate input device as claimed in claim 15 further comprising at least one lighting module to provide a light source for the first capture module and the second capture module.

17. The optical coordinate input device as claimed in claim 1, further comprising:
a memory unit for storing an object image template;
a marking module electrically connected with the identification module to execute a connected component labeling approach based on the first thresholding image and the second thresholding image respectively to obtain at least one object image, and to determine if the at least one object image corresponds with the object image template, if so, then the identification module calculates the coordinate.

18. The optical coordinate input device as claimed in claim 17, wherein:
the first capture module captures a first background image in advance;
the second capture module captures a second background image in advance;
the memory unit stores the first background image and the second background image; and
the identification module clips the first captured image based on the first background image and clips the second captured image based on the second background image respectively to obtain a first clipped image and a second clipped image.

19. The optical coordinate input device as claimed in claim 18, wherein the first thresholding image and the second thresholding image are obtained by using the first threshold to truncate the first clipped image and the second clipped image.

20. The optical coordinate input device as claimed in claim 18, wherein the optical coordinate input device further comprises a filtering module for filtering the clipped image and the second clipped image to obtain a first filtered image and a second filtered image; and wherein the first thresholding image and the second thresholding image are obtained by using the first threshold to truncate the first filtered image and the second filtered image.

21. The optical coordinate input device as claimed in claim 17, wherein the optical coordinate input device further comprises a filtering module for filtering the first captured image and the second captured image to obtain a first filtered image and a second filtered image; and wherein the first thresholding image and the second thresholding image are obtained by using the first threshold to truncate the first filtered image and the second filtered image.

22. The optical coordinate input device as claimed in claim 17, wherein the identification module further normalizes the object image.

23. The optical coordinate input device as claimed in claim 17, wherein the object image template is a finger image template or a touch pen image template.

24. The optical coordinate input device as claimed in claim 1, wherein the identification module uses a trigonometric function to calculate the coordinate.

25. An coordinate calculation method for an optical coordinate input device, the method comprising the following steps:
capturing a first captured image and a second captured image from a detection area;
executing a process to transform the first captured image and the second captured image into a first thresholding image and a second thresholding image respectively based on a first threshold;
determining if an object is in both the first thresholding image and the second thresholding image; and
if so, then calculating a coordinate.

26. The method as claimed in claim 25, wherein the step of executing a process to transform the first captured image and the second captured image into a first thresholding image and a second thresholding image further comprises:
establishing a first background image and a second background image of the detection area;
clipping the first captured image based on the first background image and the second captured image based on the second background image respectively to obtain a first clipped image and a second clipped image; and
truncating the first threshold and the second clipped image to obtain the first thresholding image and the second thresholding image respectively.

27. The method as claimed in claim 26, wherein the step of determining if an object is in both the first thresholding image and the second thresholding image further comprises:
calculating a first number of bright dots of the first thresholding image and a second number of bright dots of the second thresholding image respectively;
determining if the first number and the second number exceed a second threshold; and
if so, then determining that an object exists.

28. The method as claimed in claim 27 further comprising a step of re-establishing the first background image and the second background image.

29. The method as claimed in claim 25, wherein the step of executing a process to transform the first captured image and the second captured image into a first thresholding image and a second thresholding image further comprises:
filtering the first captured image and the second captured image to obtain a first filtered image and a second filtered image; and
using the first threshold to truncate the first filtered image and the second filtered image to obtain the first thresholding image and the second thresholding image respectively.

30. The method as claimed in claim 25, wherein the step of executing a process to transform the first captured image and the second captured image into a first thresholding image and a second thresholding image further comprises:
capturing a first background image and a second background image in advance;
clipping the first captured image based on the first background image and the second captured image based on the second background image respectively to obtain a first clipped image and a second clipped image;
filtering the first clipped image and the second clipped image to obtain a first filtered image and a second filtered image; and
using the first threshold to truncate the first filtered image and the second filtered image to obtain the first thresholding image and the second thresholding image respectively.

31. The method as claimed in claim 30, further comprising the following steps:
processing the first thresholding image and the second thresholding image with a connected component labeling approach respectively to obtain at least one object image;
determining if the at least one object image corresponds with an object image template; and
if so, then determining that the object exists.

32. The method as claim in claim 31 further comprising the step of normalizing the object image.

33. The method as claim in claim 31, further comprising the following steps:
obtaining a plurality of object images from the first thresholding image and the second thresholding image respectively; and
determining one by one if each one of the plurality of object images corresponds with the object image template according to an order of area size of each one of the plurality of object images.

34. The method as claimed in claim 29, further comprising the following steps:
processing the first thresholding image and the second thresholding image with a connected component labeling approach respectively to obtain at least one object image;
determining if the at least one object image corresponds with an object image template; and
if so, then determining that the object exists.

35. The method as claim in claim 34 further comprising the step of normalizing the object image.

36. The method as claim in claim 34, further comprising the following steps:
obtaining a plurality of object images from the first thresholding image and the second thresholding image respectively; and
determining one by one if each one of the plurality of object images corresponds with the object image template according to an order of area size of each one of the plurality of object images.

37. The method as claimed in claim 26, further comprising the following steps:
processing the first thresholding image and the second thresholding image with a connected component labeling approach respectively to obtain at least one object image;
determining if the at least one object image corresponds with an object image template; and
if so, then determining that the object exists.

38. The method as claim in claim 37 further comprising the step of normalizing the object image.

39. The method as claim in claim 37, further comprising the following steps:
obtaining a plurality of object images from the first thresholding image and the second thresholding image respectively; and
determining one by one if each one of the plurality of object images corresponds with the object image template according to an order of area size of each one of the plurality of object images.

40. The method as claim in claim 25, wherein the step of calculating a coordinate further comprises:
using a trigonometric function to calculate the coordinate.

41. An coordinate calculation method for an optical coordinate input device, the method comprising the following steps:
establishing a first background image and a second background image of a detection area in advance;
capturing a first captured image and a second captured image from the detection area;
comparing the first background image with the first captured image, and comparing the second background image with the second captured image respectively to obtain a first clipped image and a second clipped image;
determining if an object is in both the clipped image and the second clipped image; and
if so, then calculating a coordinate.

42. The method as claimed in claim 41, wherein the step of determining if an object is in both the clipped image and the second clipped image further comprises:
using a first threshold to filter the first clipped image and the second clipped image to obtain a first and a second thresholding image respectively;
calculating a first number of bright dots of the first thresholding image and a second number of bright dots of the second thresholding image respectively;
determining if the first number and the second number exceed a second threshold; and
if so, then determining that the object exists.
